(19) United States
(12) Patent Application Publication
(10) Pub. No.: US 2007/0053386 A1
(43) Pub. Date: Mar. 8, 2007

(54) Apparatus and method for controlling optical power level

(75) Inventor: Se-Tae Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/503,980

(22) Filed: Aug. 15, 2006

(30) Foreign Application Priority Data
Aug. 16, 2005 (KR) 2005-74927

(51) Int. Cl. H01S 3/00

(52) U.S. Cl. 372/1

(57) ABSTRACT

An apparatus and a method for controlling an optical power level are provided. The apparatus includes a power supply unit supplying power in response to an exposure control signal corresponding to an input image signal and a light scanning unit driven using the power and irradiating light having optical power corresponding to an input sample-and-hold signal onto a photosensitive drum.

### CROSS-REFERENCE TO RELATED PATENT APPLICATIONS

This application claims the benefit under 35 U.S.C. §119(a) of Korean Patent Application No. 10-2005-0074927, filed on Aug. 16, 2005, in the Korean Intellectual Property Office, the entire disclosure of which is hereby incorporated by reference.

### BACKGROUND OF THE INVENTION

1. Field of the Invention

The present invention relates to optical power control of a light source. More particularly, the present invention relates to an apparatus and a method for controlling an optical power level in which M light sources (where M is a positive integer) used in an electrophotographic printer irradiate light having optical power corresponding to a selected optical power level among N optical power levels (where N is an integer greater than M and where N is greater than or equal to 2) onto a photosensitive drum.

2. Description of the Related Art

A light source disposed in an electrophotographic printer irradiates light onto a photosensitive drum disposed in the electrophotographic printer. This facilitates the formation of an electrostatic latent image of printing data. Examples of electrophotographic printers include at least one of a laser printer and a multifunctional peripheral (MFP) comprising a laser printing function.

The appearance of printing data which is printed on a printing medium using an electrophotographic printer varies according to optical power of light irradiated onto the photosensitive drum to form an electrostatic latent image of the printing data. The printed appearance refers to the brightness of printed data.

In this case, each light source disposed in an electrophotographic printer irradiates light and comprises one optical power level. Thus, when the number of optical power levels of light irradiated onto the photosensitive drum disposed in the electrophotographic printer is set to K (where K is an integer that is greater than or equal to 2) using a conventional apparatus for controlling an optical power level, K light sources must be disposed in the electrophotographic printer.

The conventional apparatus for controlling an optical power level requires the same number of light sources as the number of optical power levels of light irradiated onto the photosensitive drum disposed in the electrophotographic printer. As the number of optical power levels of light increases, the number of light sources to be disposed in the electrophotographic printer also increases. This increases the cost of manufacturing the electrophotographic printer.

As the number of optical power levels of light irradiated onto the photosensitive drum disposed in the electrophotographic printer increases in the conventional apparatus, space in the electrophotographic printer is reduced due to the increased number of light sources required. Therefore, it is difficult to reduce the size of the electrophotographic printer.

Furthermore, in the conventional apparatus for controlling an optical power level, as the number of optical power levels of light irradiated onto the photosensitive drum disposed in the electrophotographic printer increases, the possibility that mis-alignment between the increased number of light sources may occur increases, and the possibility of degradation of image quality caused by mis-alignment also increases.

Accordingly, there is a need for an improved system and method for providing an apparatus for controlling an optical power level without increasing mis-alignment and the degradation of image quality.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus for controlling an optical power level in which M light sources (where M is a positive integer) used in an electrophotographic printer irradiate light having optical power corresponding to a selected optical power level among N optical power levels (where N is an integer greater than M and greater than or equal to 2) onto a photosensitive drum.

An exemplary embodiment of the present invention also provides a method of controlling an optical power level by which M light sources (where M is a positive integer) used in an electrophotographic printer irradiate light having optical power corresponding to a selected optical power level among N optical power levels (where N is an integer greater than M and greater than or equal to 2) onto a photosensitive drum.

An exemplary embodiment of the present invention also provides a computer-readable recording medium having recorded thereon a program for executing the method of controlling an optical power level by which M light sources (where M is a positive integer) used in an electrophotographic printer irradiate light having optical power corresponding to a selected optical power level among N optical power levels (where N is an integer greater than M and greater than or equal to 2) onto a photosensitive drum.

According to an aspect of the present invention, there is provided an apparatus for controlling an optical power level comprising a power supply unit and a light scanning unit. The power supply unit supplies power in response to an exposure control signal corresponding to an input image signal. The light scanning unit is driven using the power and irradiating light that has set optical power corresponding to an input sample-and-hold signal onto a photosensitive drum.

According to another aspect of the present invention, there is provided a method of controlling an optical power level. Power is generated according to an exposure control signal that corresponds to a given image signal. Light that has a set optical power corresponding to a given sample-and-hold signal is generated using the power. The light is then irradiated onto a photosensitive drum.

According to still another aspect of the present invention, there is provided a computer-readable recording medium having recorded thereon a program for executing a method of controlling an optical power level, wherein the program controls the method according to a process. Power is generated according to an exposure control signal corresponding to a given image signal. Light that has a set optical power corresponding to a given sample-and-hold signal using the power is generated. The light is then irradiated onto a photosensitive drum.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of an apparatus for controlling an optical power level according to an exemplary embodiment of the present invention;

FIG. 2 is a circuit diagram of a light scanning unit illustrated in FIG. 1 according to an exemplary embodiment of the present invention;

FIG. 3 is a gate diagram of a matching unit illustrated in FIG. 1 according to an exemplary embodiment of the present invention;

FIG. 4 is a timing diagram of signals for illustrating a principle of controlling an optical power level using the apparatus for controlling an optical power level illustrated in FIG. 1; and

FIG. 5 is a flowchart illustrating a method of controlling an optical power level according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. The present invention will now be described more fully with reference to the accompanying drawings, in which exemplary embodiments of the invention are shown. More specifically, an apparatus and a method for controlling an optical power level in which M light sources (where M is a positive integer) used in an electrophotographic printer irradiate light having optical power corresponding to a selected optical power level among N optical power levels (where N is an integer greater than M and greater than or equal to 2) onto a photosensitive drum will now be described more fully with reference to the accompanying drawings.

The following terms are defined in consideration of functions in exemplary embodiments of the present invention and can be changed according to the intentions of a user.

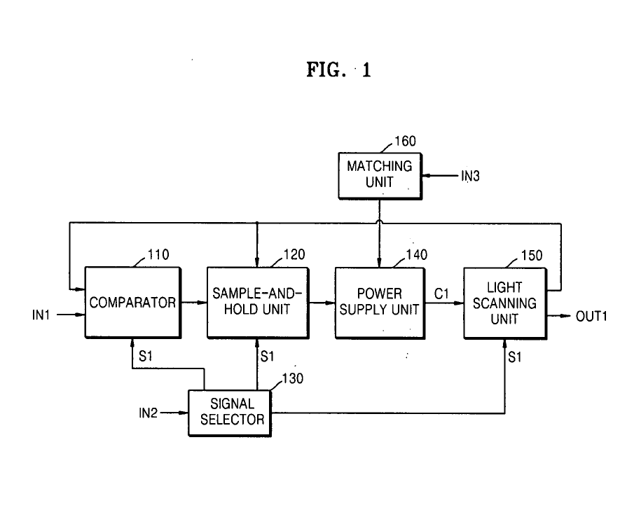

FIG. 1 is a block diagram of an apparatus for controlling an optical power level according to an exemplary embodiment of the present invention. The apparatus of FIG. 1 includes a comparator 110, a sample-and-hold unit 120, a signal selector 130, a power supply unit 140, a light scanning unit 150 and a matching unit 160.

All of the elements of the apparatus illustrated in FIG. 1 may be disposed in an electrophotographic printer, such as a laser printer or a multifunctional peripheral (MFP) having a laser printing function.

A light source disposed in an electrophotographic printer forms an electrostatic latent image of printing data by irradiating light onto a photosensitive drum disposed in the electrophotographic printer. M light sources may be disposed in the electrophotographic printer.

The comparator 110 operates in response to an input sample-and-hold signal S1 and compares optical power of light irradiated onto the photosensitive drum with reference optical power IN1. More specifically, the comparator 110 operates during a pulse-width period of the input sample-and-hold signal S1.

If the optical power of light irradiated onto the photosensitive drum is less than the reference optical power IN1, the optical power of light irradiated onto the photosensitive drum is increased until it reaches the reference optical power IN1.

In this case, the optical power of light irradiated onto the photosensitive drum may reach the reference optical power IN1 before the pulse-width period of the input sample-and-hold signal S1 elapses.

If the optical power of light irradiated onto the photosensitive drum is equal to the reference optical power IN1, the comparator 110 instructs the sample-and-hold unit 120 to operate.

N comparators 110 may be used. According to an exemplary implementation, N reference optical power levels may be set.

The sample-and-hold unit 120 operates in response to the input sample-and-hold signal S1 and samples the optical power of the light irradiated onto the photosensitive drum. More specifically, the sample-and-hold unit 120 samples the optical power that is equal to the reference optical power IN1 among the optical power of the light irradiated onto the photosensitive drum. The sample-and-hold unit 120 sets the sampled optical power to set optical power.

As described above, the comparator 110 and the sample-and-hold unit 120 operate in response to the input sample-and-hold signal S1. The input sample-and-hold signal S1 may be one of N sample-and-hold signals. According to an exemplary implementation, the N sample-and-hold signals may be preset as sample-and-hold signals that can be input to the comparator 110 and the sample-and-hold unit 120.

The signal selector 130 selects a sample-and-hold signal S1 of the N sample-and-hold signals. Referring to FIG. 1, IN2 represents the N sample-and-hold signals. The sample-and-hold signal S1 selected by the signal selector 130 is input to the comparator 110 and the sample-and-hold unit 120.

A sample-and-hold signal selected by the signal selector 130 may be referred to as an activated sample-and-hold signal, and a non-selected sample-and-hold signal may be referred to as an inactivated sample-and-hold signal.

The power supply unit 140 supplies power to the light scanning unit 150 in response to an exposure control signal corresponding to an input image signal IN3. According to an exemplary implementation, the image signal IN3 is a signal that represents printing data provided to an electrophotographic printer. The exposure control signal is a signal that controls on/off of a light source and is generated in response to the image signal IN3.

At this time, there may be N image signals IN3. There may be M exposure control signals.

That is, the power supply unit 140 can supply power to the light source in response to the M exposure control signals. The power supply unit 140 may be a current source. In this case, C1 may be a current that is generated in the power supply unit 140 and flows through the light source.

The light scanning unit 150 is driven using the power supplied by the power supply unit 140 and irradiates light having set optical power corresponding to the input sample-and-hold signal S1. M light sources may be disposed in the light scanning unit 150, and M may be 1. OUT1 may be light that is irradiated from the light source onto the photosensitive drum.

The apparatus for controlling an optical power level, according to an exemplary embodiment of the present invention, may or may not include the matching unit 160.

The matching unit 160 generates exposure control signals corresponding to the N input image signals. More specifically, the matching unit 160 may include a logic table, and the exposure control signals may match each combination of the N image signals. In this case, the matching unit 160 generates an exposure control signal matched to the combination of the N image signals. The number of the exposure control signals that can be generated by the matching unit 160 is M.

When the matching unit 160 is disposed in the apparatus for controlling an optical power level, according to an exemplary embodiment of the present invention, the power supply unit 140 supplies power to the light scanning unit 150 in response to the exposure control signals generated by the matching unit 160.

FIG. 2 is a circuit diagram of the light scanning unit 150 illustrated in FIG. 1 according to an exemplary embodiment of the present invention. Referring to FIG. 2, the light scanning unit 150 may include a light source 210, a plurality of resistors R1 and R2, and a switching unit 240. Reference numeral 200 of FIG. 2 corresponds to reference numeral 150 of FIG. 1.

Examples of the light source 210 may include a laser diode. FIG. 2 is a circuit diagram illustrating an example of the light scanning unit 200. M is 1 and N is 2. Accordingly, one light source 210 is disposed in the light scanning unit 200, and two resistors R1 and R2 are disposed in the light scanning unit 200.

The resistors R1 or R2 may be variable resistors. In addition, the switching unit 240 may include one switch. The switch is switched in response to the input sample-and-hold signal S1.

More specifically, the switching unit 240 is switched in response to the input sample-and-hold signal S1 and can be connected to one of the resistors R1 and R2. If N=2, optical power of light irradiated onto the photosensitive drum using the apparatus for controlling an optical power level according to the exemplary embodiment of the present invention is referred to as first and second optical power.

For example, if the input sample-and-hold signal S1 is a signal that instructs the switching unit 240 to be connected to the resistor R1, the current C1 that has flowed through the light source 210 flows through the resistor R1 to generate first optical power.

Similarly, if the input sample-and-hold signal S1 is a signal that instructs the switching unit 240 to be connected to the resistor R2, the current C1 that has flowed through the light source 210 flows through the resistor R2 to generate second optical power.

According to an exemplary embodiment of the present invention, optical power of the light irradiated onto the photosensitive drum can be controlled when the switching unit 240 is switched in response to the sample-and-hold signal S1 and the set optical power is determined by whichever resistor R1 or R2 is connected.

According to another exemplary embodiment of the present invention, optical power of the light irradiated onto the photosensitive drum can be controlled when the reference optical power IN1 varies according to the sample-and-hold signal S1. In this case, one resistor is disposed in the light scanning unit 150, and the light source 210 and the resistor can be constantly connected to each other.

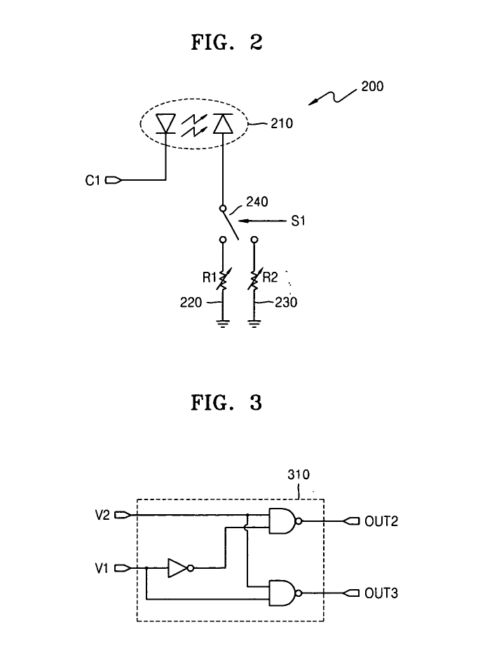

FIG. 3 is a gate diagram of the matching unit 160 illustrated in FIG. 1, according to an exemplary embodiment of the present invention. Reference numeral 310 of FIG. 3 corresponds to reference numeral 160 of FIG. 1. Even in FIG. 3, N=2.

Image signals V1 and V2 and exposure control signals OUT2 and OUT3 can be used to realize a logic table shown in Table 1.

TABLE 1

| | | | | |
|---|---|---|---|---|
| V1 | 0 | 1 | 0 | 1 |
| V2 | 1 | 1 | 0 | 0 |
| First optical power | 0 | 1 | 1 | 1 |
| Second optical power | 1 | 0 | 1 | 1 |

According to an exemplary implementation, the image signals V1 and V2 and the exposure control signals OUT2 and OUT3 are assumed when the matching unit 160 operates at active low. That is, 0 means on and 1 means off.

In an exemplary implementation, only one optical power thereof is selectively turned on since the first optical power and the second optical power cannot both be on. In FIG. 3, the first optical power is turned on when the image signal V1 is turned on.

The gate diagram illustrated in FIG. 3 is an example of the matching unit 160. A variety of gate diagrams for realizing the matching unit 160 can be used. If M=1, the exposure control signals OUT2 and OUT3 are the same, and if M≠1, the exposure control signals OUT2 and OUT3 are different.

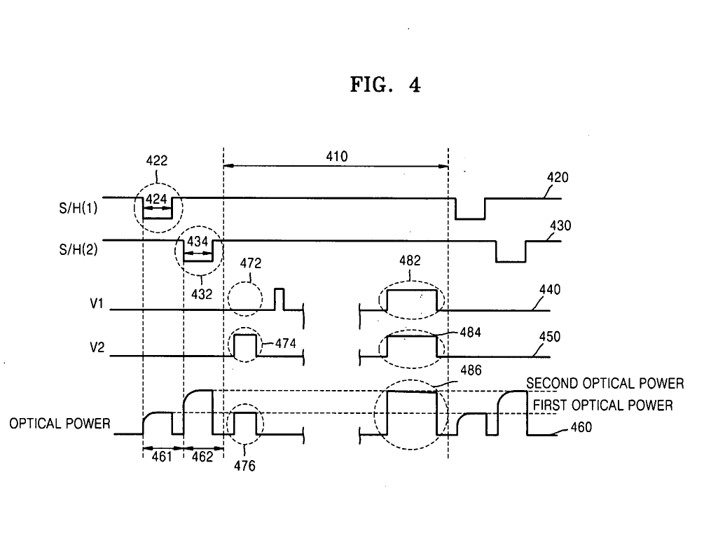

FIG. 4 is a timing diagram of signals for illustrating a principle of controlling an optical power level using the apparatus for controlling an optical power level illustrated in FIG. 1, when M=1 and N=2. Reference numerals 420, 430, 440, 450, and 460 refer to a first sample-and-hold signal, a second sample-and-hold signal, V1, V2, and optical power, respectively. Although not illustrated, the horizontal axis represents time.

The printing data provided to the electrophotographic printer may be printing data of a document composed of a plurality of pages. In this case, the appearance of the printing data on the printing medium can be set for each page. At this time, the appearance of the printing data on the printing medium is determined according to optical power of light irradiated onto the photosensitive drum.

Reference numeral 410 is an image section. The image section is a period in which an image signal V1 or V2 is provided and a non-image section is a period in which the image signal V1 or V2 is not provided. For example, if the printing data is printing data of a document composed of a plurality of pages, a corresponding image section exists in each page.

Referring to FIG. 4, since N=2, the number of levels of optical power of the light irradiated onto the photosensitive drum using the apparatus for controlling an optical power level is 2, and the optical power includes a first optical power and a second optical power, respectively.

The number of each of first optical power and second optical power levels may be determined before the first and second optical power reach the image section 410. To this end, a pulse-width signal 422 of the first sample-and-hold signal 420 and a pulse-width signal 432 of the second sample-and-hold signal 430 may be generated before they reach the image section 410.

A pulse-width section 424 of the pulse-width signal 422 of the first sample-and-hold signal 420 is smaller than a section indicated by reference numeral 461 of the optical power signal 460, and a pulse-width section 434 of the pulse-width signal 432 of the second sample-and-hold signal 430 is smaller than a section indicated by reference numeral 462 of the optical power signal 460.

In FIG. 4, the optical power signal 460 is a signal that is generated when the light scanning unit 150 operates in response to an exposure control signal (not illustrated) generated when the V1 signal 440 and the V2 signal 450 pass through the matching unit 310 of FIG. 3.

For example, if the V1 signal 440 is turned on (472) and the V2 signal 450 is turned off (474), M light sources (where M is 1) disposed in: the light scanning unit 150 irradiate light (476) having first optical power onto the photosensitive drum.

In addition, if the V1 signal 440 is turned off (482) and the V2 signal 450 is turned off (484), M light sources (where M is 1) disposed in the light scanning unit 150 irradiate light (486) having second optical power onto the photosensitive drum.

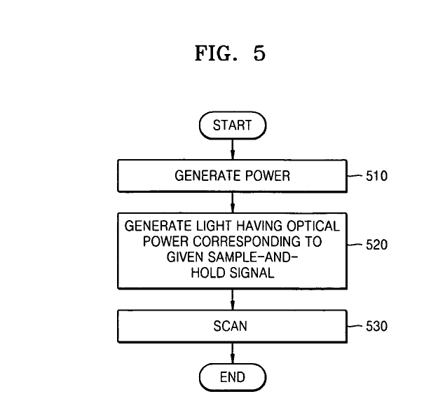

FIG. 5 is a flowchart illustrating a method of controlling an optical power level according to an exemplary embodiment of the present invention. The method of FIG. 5 comprises irradiating (operations 510 to 530) light having optical power corresponding to a selected optical power level among N optical power levels (where N is an integer greater than M and greater than or equal to 2) onto a photosensitive drum using M light sources (where M is a positive integer) used in an electrophotographic printer.

In operation 510, the power supply unit 140 generates power in response to an exposure control signal corresponding to a predetermined image signal. In operation 520, the light scanning unit 150 generates light having set optical power corresponding to a given sample-and-hold signal using the power. In operation 530, the light scanning unit 150 scans the light onto the photosensitive drum.

Exemplary implementations of the present invention may also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the exemplary embodiments of present invention may be easily construed by programmers skilled in the art.

In the apparatus and method for controlling an optical power level according to the present invention, the number of optical power levels of light irradiated by M light sources (where M is a positive integer) onto the photosensitive drum disposed in the electrophotographic printer is N (where N is an integer greater than M and greater than or equal to 2). Therefore, the same number of light sources as the number of optical power levels of light irradiated onto the photosensitive drum does not need to be disposed in the electrophotographic printer, such that the cost of manufacturing the electrophotographic printer is reduced and the size of the electrophotographic printer is reduced. The possibility that mis-alignment between light sources may occur increases as the number of light sources increases. Knowledge of this reduces the possibility of degradation of image quality caused by mis-alignment.

While the present invention has been particularly shown and described with reference to exemplary embodiments thereof, it will be understood by those of ordinary skill in the art that various changes in form and details may be made therein without departing from the spirit and scope of the present invention as defined by the appended claims and their equivalents.

What is claimed is:

1. An apparatus for controlling an optical power level comprising:
a power supply unit for supplying power in response to an exposure control signal corresponding to an input image signal; and
a light scanning unit, driven using the power, for irradiating light comprising set optical power corresponding to an input sample-and-hold signal onto a photosensitive drum.

2. The apparatus of claim 1, wherein the light scanning unit comprises M places in which light scanning is to be performed and the set optical power comprises N settable levels, wherein N and M are integers.

3. The apparatus of claim 1, further comprising a sample-and-hold unit for sampling optical power equal to a reference optical power among optical power of light irradiated onto the photosensitive drum in response to the input sample-and-hold signal and setting the sampled result as the set optical power.

4. The apparatus of claim 3, wherein the reference optical power comprises power variable according to the input sample-and-hold signal.

5. The apparatus of claim 1, wherein the light scanning unit comprises:
a plurality of resistors; and
a switching unit switchable in response to the input sample-and-hold signal and connectable to one of the resistors, wherein the power is applied to the connected resistor.

6. The apparatus of claim 5, wherein the resistor comprises a variable resistor.

7. The apparatus of claim 1, further comprising a matching unit generating the exposure control signal corresponding to at least one input image signal, wherein the power supply unit supplies the power to the light scanning unit in response to the generated exposure control signal.

8. The apparatus of claim 7, wherein the matching unit generates the exposure control signal matching all the one or more input image signals among the exposure control signals matching each of combination of a plurality of image signals.

9. The apparatus of claim 1, wherein the photosensitive drum is disposed in an electrophotographic printer.

10. A method of controlling an optical power level comprising:
generating power according to an exposure control signal corresponding to an image signal;
generating light comprising set optical power corresponding to a sample-and-hold signal using the power; and
irradiating the light onto a photosensitive drum.

11. The method of claim 10, further comprising disposing M places in which light scanning is to be performed by the light wherein the set optical power comprises N settable power levels wherein M and N are integers.

12. The method of claim 10, further comprising:
sampling optical power equal to a reference optical power among optical power of light irradiated onto the photosensitive drum in response to the sample-and-hold signal; and
setting the sampled result as the set optical power.

13. The method of claim 12, wherein the reference optical power comprises power variable according to the sample-and-hold signal.

14. The method of claim 10, wherein the generation of the light comprises:
switching a switching unit in response to the sample-and-hold signal and connecting the switching unit to one of a plurality of resistors; and
generating light comprising the set optical power by applying the power to the connected resistor.

15. The method of claim 10, wherein the generation of the power comprises:
generating the exposure control signal corresponding to all the one or more image signals; and
generating the power in response to the generated exposure control signal.

16. A computer-readable recording medium comprising recorded thereon a program for executing a method of controlling an optical power level, wherein the program controls the method according to a process comprising:
generating power according to an exposure control signal corresponding to an image signal;
generating light comprising set optical power corresponding to a sample-and-hold signal using the power; and
irradiating the light onto a photosensitive drum.

17. The apparatus of claim 2, wherein N is greater than M.

18. The apparatus of claim 2, wherein N is greater than M or equal to 2.

19. The apparatus of claim 7, wherein the matching unit generates the exposure control signal matching at least one input image signal among the exposure control signals matching at least one of a combination of a plurality of image signals.

20. The method of claim 11, wherein N is greater than M.

21. The method of claim 11, wherein N is greater than M or equal to 2.

22. The method of claim 10, wherein the generation of the power comprises:
generating the exposure control signal corresponding to all the one or more image signals; and
generating the power in response to the generated exposure control signal

23. An apparatus for controlling an optical power level comprising:
a power supply unit for supplying power in response to an exposure control signal corresponding to input image signal;
a light scanning unit for irradiating light onto a photosensitive drum;
a comparator for comparing optical power of light irradiated onto the photosensitive drum with a reference optical power; and
a signal selector for selecting a sample-and-hold signal.

24. The apparatus as claimed in claim 23, wherein the light scanning unit is driven using the power.

25. The apparatus as claimed in claim 23, wherein, the irradiated light comprises set optical power corresponding to an input sample-and-hold signal.

26. The apparatus as claimed in claim 23, wherein the comparator operates during a pulse width period of an input sample-and-hold signal.
